(19) United States
(12) Patent Application Publication
(10) Pub. No.: US 2008/0191648 A1
(43) Pub. Date: Aug. 14, 2008

(54) Closed Loop Control Of Linear Vibration Actuator

(76) Inventors: Yoshiteru Ito, Kadoma-shi (JP); Subrata Saha, Anjo-shi (JP); Taro Kishibe, Nishinomiya-shi (JP); Shinichiro Kawano, Daito-shi (JP); Koji Kameda, Moriguchi-shi (JP); Kazushige Narazaki, Katano-shi (JP); Yasufumi Ikkai, Kobe-shi (JP); Noriyoshi Nishiyama, Izumiotsu-shi (JP)

Correspondence Address: RATNERPRESTIA, P.O. BOX 980, VALLEY FORGE, PA, 19482, US

(21) Appl. No.: 10/546,466

(22) PCT Filed: Feb. 27, 2003
(86) PCT No.: PCT/JP2003/002238

§ 371 Date: Apr. 17, 2007

(51) Int. Cl. H02P 7/29; A61H 1/00; A63F 13/06; H04M 1/00

(52) U.S. Cl. 318/128; 455/550.1; 463/36; 601/46

(57) ABSTRACT

In a closed loop control method of a linear vibration actuator which vibrates linearly and energized by a switching element driven in a PWM control method, a crest or peak point (B_{c}, Bₚ) of the back electromotive force occurring in the linear vibration actuator is detected (S14). The detected crest or peak point (B_{c}, Bₚ) is compared with a reference value (B_{cr}, Bₚᵣ) (S15), and adjusting the PWM duty (α) applied to the switching element and controlling the operating frequency of the linear vibration actuator to resonant frequency (S16 to S19), thereby keeping the crest or peak point (B_{c}, Bₚ) of the back electromotive force always constant.

### TECHNICAL FIELD

The present invention relates to a closed loop control technique for a linear vibration actuator with the help of a micro-controller.

### BACKGROUND ART

Recently linear vibration actuators (LVA) are finding application in cellular phones for generating vibration, used as an alarm for incoming calls. The cross-sectional view of the LVA is shown in FIG. 19. The LVA 100 includes a magnet 101, a weight 103 and a resonant spring 105 which carries the magnet 101 and the weight 103. From FIG. 19 it can be understood that the LVA has a vertical (up and down) motion instead of a horizontal one making it highly suitable for the use in cellular phones. The vibration in a LVA is generated when it is operated in open loop at a predetermined resonant frequency (fᵣ). The resonant frequency (fᵣ) of the LVA is given by,

$${f}_{r} = \frac{1}{2 π} \sqrt{\frac{k}{m}} \qquad ( 1 )$$

where, m is the mass of the weight 103 and k is the spring constant of the spring 105. The sensitivity of vibration depends on the stroke-length of the LVA. Typically, most of the LVAs are designed between a resonant frequency (fᵣ) range of 135 Hz to 170 Hz and the sensitivity of vibration is kept between 90 dB to 110 dB. In the present available technology, the LVA is driven in open loop by a transistor with 50% ON-duty and operated from a power supply of 1.4 V. A basic driving circuit of the LVA with a free running astable multi-vibrator is shown in FIG. 20. The stable multi-vibrator with 50% ON-duty and varying frequency can be realized by a simple analog and digital circuit or by the software of a micro-controller. The resonant frequency (fᵣ) of the LVA generally varies between ±8 Hz and is affected by the change in the values of the parameters k and m in equation (1). If the LVA is always rotated at a constant predetermined resonant frequency (fᵣ), the stroke length of the LVA i.e. the sensitivity of vibration decreases with the variation in resonant frequency during actual operation. Another demerit of the present open loop control strategy is the high energy consumption by the LVA as the PWM ON-duty of the transistor is always kept constant at 50% and hence, faster consumption of the battery charge.

The present invention aims to operate the LVA in closed loop with the help of a micro-controller by sensing the back electromotive force (emf) during the transistor OFF period, so that the resonant frequency (fᵣ) of the LVA is automatically tracked.

### DISCLOSURE OF INVENTION

In the first aspect of the invention, an apparatus for controlling a linear vibration actuator includes a switching element that alternately turns on and off to provide power intermittently to the linear vibration actuator, a drive circuit that drives the switching element in a PWM control method, an interface circuit that detects the back electromotive force of the linear vibration actuator during the OFF period of the switching element, the interface circuit connected between the junction point of the switching element and the linear vibration actuator and the AD input terminal of the controller, and a controller that controls the drive circuit based on the back electromotive force detection result by the interface circuit such that the switching element is driven at a resonant frequency.

In the second aspect of the invention, a closed loop control method of a linear vibration actuator which vibrates linearly and energized by a switching element driven in a PWM control method, includes detecting a crest or peak point (B_{c}, Bₚ) of a back electromotive force occurring in the linear vibration actuator, comparing the detected crest or peak point (B_{c}, Bₚ) with a reference value (B_{cr}, Bₚᵣ), and adjusting at least one of the parameters such as the PWM duty (α) applied to the switching element and the operating frequency (fᵣ) of the linear vibration actuator, so that the crest or peak point (B_{c}, Bₚ) of the back electromotive force is constant.

In the third aspect of the invention, a closed loop control method of a linear vibration actuator which vibrates linearly and energized by a switching element driven in a PWM control method, includes detecting the zero cross point (Z₁) in the negative slope region of the back electromotive force occurring in the linear vibration actuator, calculating an operating frequency of the linear vibration actuator based on the period between two consecutive zero cross points (Z₁) in the negative slope region of the back electromotive force, driving the switching element with the calculated operating frequency, while turning on the switching element after a turn-on delay (t_{ond}) from the instant after detecting the zero cross points (Z₁) of the back electromotive force and there by updating the turn-an delay (t_{ond}) based on the calculated operating frequency so that the PWM duty (α) is located at the center of two zero cross points (Z₀) and (Z₁), and continuously adjusting the PWM ON-duty (α) after sensing the back emf peak or crest point (Bₚ or B_{c}) and comparing it with the value of the reference back emf peak or crest point (Bₚᵣ or B_{cr}).

In the fourth aspect of the invention, a closed loop control method of a linear vibration actuator which vibrates linearly and energized by a switching element driven in a PWM control method, includes: detecting a zero cross point (Z₀) in the positive slope region and a zero cross point (Z₁) in the negative slope region of a back electromotive force occurring in the linear vibration actuator, estimating a turn-off delay (t_{offd}) based on the zero cross point (Z₀) in the positive slope region, the turn-off delay (t_{offd}) being an interval between a turn-off instant of the PWM duty pulse and an instant when the zero cross point (Z₀) in the positive slope region is detected, changing the turn-on delay (t_{ond}) so that the turn-on delay (t_{ond}) is substantially equal to the turn-off delay (t_{offd}), driving the switching element so as to turn it on with the turn-on delay (t_{ond}) after the zero cross point (Z₁) in the negative slope region is detected, and continuously adjusting the PWM O-N-duty (α) after sensing the back emf peak or crest point (Bₚ or B_{c}) and comparing it with the value of the reference back emf peak or crest point (Bₚᵣ or B_{cr}).

In the fifth aspect of the invention, a closed loop control method of a linear vibration actuator which vibrates linearly and energized by a switching element driven in a PWM control method, includes detecting a peak or crest point (Bₚ or B_{c}) of the back electromotive force occurring in the linear vibration actuator, defining a turn-on delay (t_{ond}) from the instant of the detection of the peak or crest point (Bₚ or B_{c}) of the back electromotive force, calculating an operating frequency of the linear vibration actuator based on the period between two consecutive peaks or crests (Bₚ or B_{c}) of the back electromotive force, and driving the switching element with the calculated operating frequency, while turning on the switching element with the turn-on delay (t_{ond}) after detecting the peak or crest point (Bₚ or B_{c}) of the back electromotive force.

In the sixth aspect of the invention, a closed loop control method of a linear vibration actuator which vibrates linearly and energized by a switching element driven in a PWM control method, includes detecting a peak or crest point (Bₚ or B_{c}) of the back electromotive force occurring in the linear vibration actuator, defining a turn-on delay (t_{ond}) and a turn-off delay (t_{offd}) based on the detected peak or crest point (Bₚ or B_{c}) of the back electromotive force, the turn-off delay (t_{offd}) being an interval between a turn-off instant of the PWM duty pulse and an instant corresponding to the peak or crest point (Bₚ or B_{c}) of the back electromotive force, changing the turn-on delay (t_{ond}) so that the turn-on delay (t_{ond}) is substantially equal to the turn-off delay (t_{offd}), and driving the switching element so as to turn on the switching element with the turn-on delay (t_{ond}) after detecting the peak or crest point (Bₚ or B_{c}) of the back electromotive force.

### BRIEF DESCRIPTIONS OF DRAWINGS

FIG. 1 shows the first drive circuit according to the invention including the first interface circuit for the closed loop control of the LVA.

FIG. 2 shows waveforms of a back emf of the LVA at the A/D input of the micro-controller for the first drive circuit and a PWM pulse.

FIG. 3A shows the second drive circuit according to the invention including the second interface circuit for the closed loop control of the LVA.

FIG. 3B shows the third drive circuit according to the invention including the third interface circuit for the closed loop control of the LVA.

FIG. 4 shows waveforms of the back emf of the LVA at the A/D input of the micro-controller for the second interface circuit and PWM pulses.

FIG. 5 shows the flowchart for the first algorithm of a control method of the LVA according to the present invention.

FIG. 6 shows waveforms of a back emf of the LVA at the A/D input of the micro-controller for the first algorithm and PWM pulses.

FIG. 7 shows the flowchart for the second algorithm of a control method of the LVA according to the present invention.

FIG. 8 shows waveforms of a back emf of the LVA at the A/D input of the micro-controller for the second algorithm and PWM pulses.

FIG. 9 shows the flowchart for the third algorithm of a control method of the LVA according to the present invention.

FIG. 10 shows waveforms of a back emf of the LVA at the A/D input of the micro-controller for the fourth algorithm and PWM pulses.

FIGS. 11A and 11B show the flowchart for the fourth algorithm of a control method of the LVA according to the present invention.

FIG. 12 shows waveforms of a back emf of the LVA at the A/D input of the micro-controller for the fifth algorithm and PWM pulses.

FIGS. 13A to 13C show the flowchart for the fifth algorithm of a control method of the LVA according to the present invention.

FIG. 14 shows waveforms of a back emf of the LVA at the A/D input of the micro-controller for the sixth or seventh algorithm and PWM pulses.

FIGS. 15A and 15B show the flowchart for the sixth algorithm of a control method of the LVA according to the present invention.

FIGS. 16A and 16B show the flowchart for the seventh algorithm of a control method of the LVA according to the present invention.

FIG. 17 shows a cellular phone including a vibrator containing a LVA and a drive circuit driving the LVA according to the present invention.

FIGS. 18A and 18B show a game controller including a vibrator containing a LVA and a drive circuit driving the LVA according to the present invention.

FIG. 18C shows a healthy band including a vibrator containing a LVA and a drive circuit driving the LVA according to the present invention.

FIG. 19 shows the cross-sectional view of a linear vibration actuator (LVA).

FIG. 20 shows a conventional open-loop drive circuit of a LVA.

### BEST MODE FOR CARRYING OUT THE EXPERIMENT

Preferred embodiments of the present invention are described below with accompanying figures.

### 1. HARDWARE CONFIGURATION

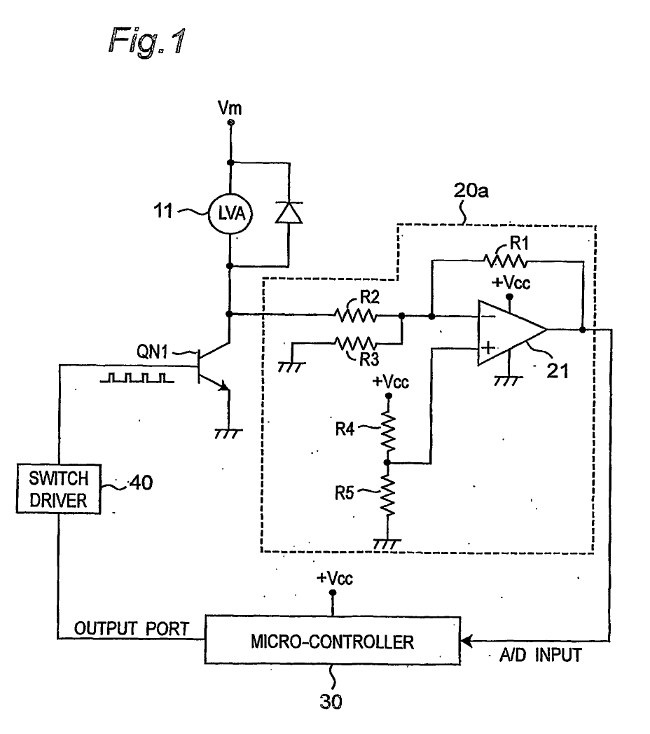

FIG. 1 shows one example of a drive circuit of a linear vibration actuator (LVA) according to the present invention. The drive circuit that drives the LVA 11 in closed-loop control includes a drive transistor QN1, an interface circuit 20a that detects a back electromotive force (emf) of the LVA 11, a micro-controller 30 that controls the operation of the drive transistor QN1, and a switch driver 40 that drives the transistor QN1 based on a control signal from the micro-controller 30.

The LVA 11 is preferably operated at a supply voltage ranging from 1.4 V to 4.2 V.

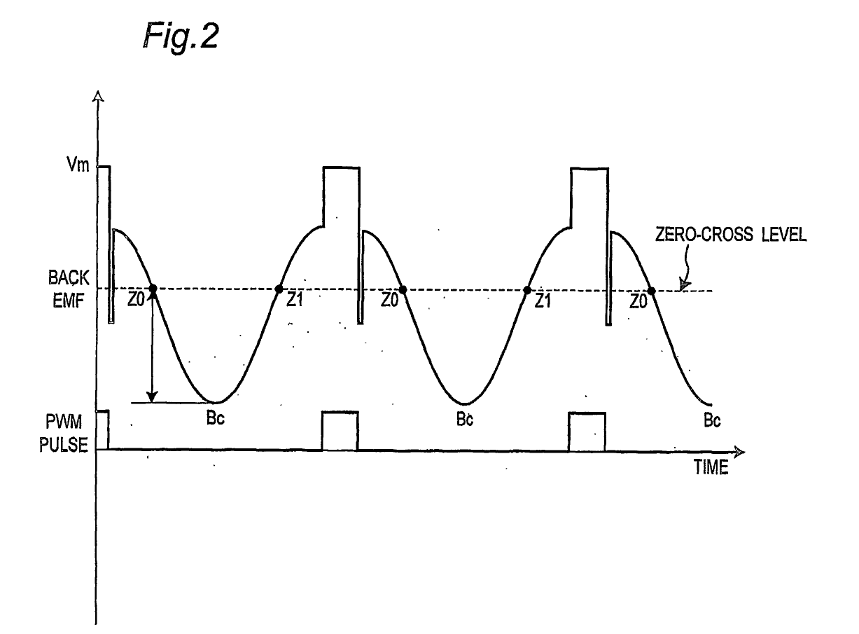

The interface circuit 20a includes an operational amplifier 21 between the collector of the drive transistor QN1 and an A/D input of the micro-controller 30. The interface circuit 20a further includes a resistor divider circuit including resistors R2 and R3 and a resistor divider circuit including resistors R4 and R5. The transistor QN1 is driven from an output port of the micro-controller 30. The operational amplifier 21 functions as a level shifter and the zero-cross level is decided by the resistor divider circuit including resistors R4 and R5. The gain of the operational amplifier 21 is adjusted for accurate A/D sensing. The inverted back emf of the LVA 11 with the zero-cross level as seen by the A/D input of the micro-controller 30 is shown in FIG. 2.

A closed-loop operation of the LVA 11 can be performed with different algorithms which are described later. All these algorithms require the sensing of the magnitude of the back emf crest point (B_{c}) defined from the zero-cross level. The information of the timing instants when zero-cross points (Z₀) and (Z₁) in the negative and positive back emf slope region respectively have occurred, is also required for operating the LVA 11 always at resonant frequency (fᵣ).

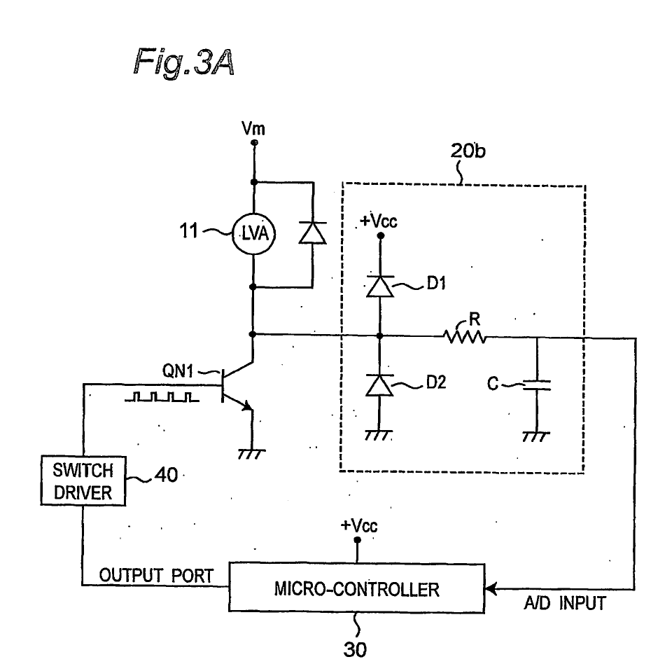

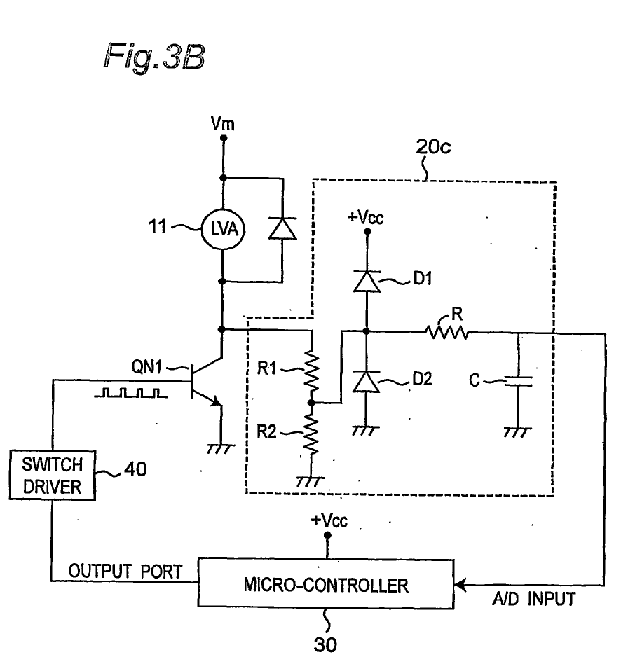

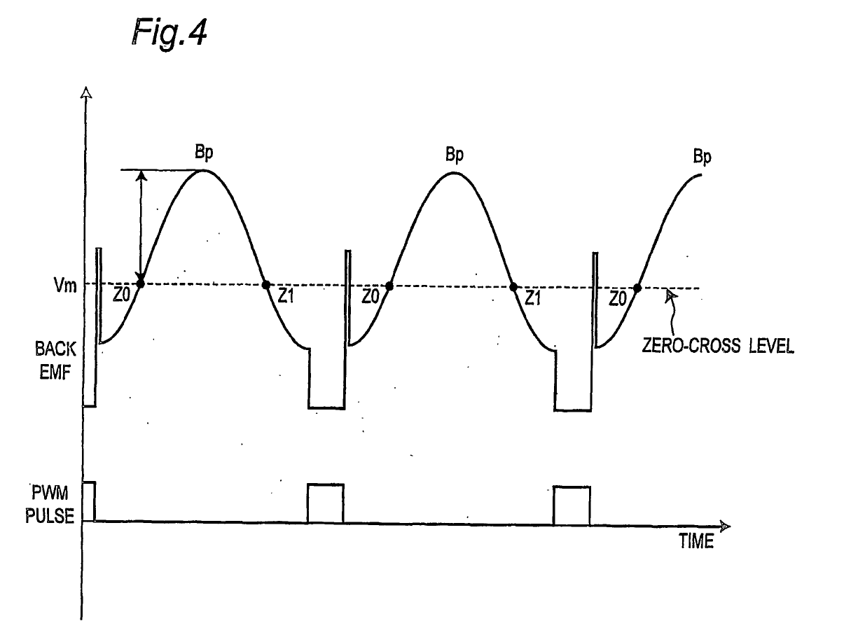

FIG. 3A shows another example of a drive circuit including the second interface circuit that detects the back emf of the LVA 11. The second interface circuit 20b includes clamping diodes D1 and D2 and a filter circuit which includes a resistor R and a capacitor C and connected between the collector of the drive transistor QN1 and the A/D input of the micro-controller 30. The back emf of the LVA 11 as seen by the AND input of the micro-controller 30 is shown in FIG. 4. The zero-cross level is decided by the supply voltage Vₘ of the actuator 11.

FIG. 3B shows another example of a drive circuit including the third interface circuit, in which a resistor divider network consisting of R1 and R2 is added to the configuration shown in FIG. 3A. Such a resistor divider network in the third interface circuit 20c can convert the magnitude of the back emf into compatible A/D sensing levels of the micro-controller 30.

With the drive circuit having the interface circuit shown in FIG. 3A or 3B, the closed loop operation of the LVA 11 can be performed with different algorithms described below. In this case, all these algorithms require the sensing of the magnitude of the back emf peak point (Bₚ) defined from the zero-cross level. Similarly, information of the timing when zero-cross points (Z₀) and (Z₁) in the positive and negative back emf slope region respectively have occurred, is also required for operating the LVA always at resonant frequency (fᵣ).

The magnitude of the inverted back emf crest point (B_{c}) or the back emf peak point (Bₚ) which is detected by the above described interface circuit is directly proportional to the stroke length or the sensitivity of vibration of the LVA. Hence, the closed loop operation of LVA 11 is performed to keep the magnitude of the back emf crest point (B_{c}) or the back emf peak point (Bₚ) constant and to make the PWM ON-duty at the center of two zero cross points (Z₀) and (Z₁), as shown in FIGS. 2 and 4. This automatically ensures operation of the LVA 11 always at resonant frequency (fᵣ) with minimum PWM ON-duty and hence energy efficient operation.

### 2. CONTROL METHOD

Some embodiments of a control method of the LVA are described below for the drive circuit including the second interface circuit 20b. However the following embodiments are also valid for the drive circuit including the first or third interface circuit 20a or 20c with necessary modifications.

According to the following control methods, the LVA is operated in closed loop control by sensing its back electromotive force (emf) during the transistor OFF period, so that the operating resonant frequency (fᵣ) is automatically tracked. Hence, the stroke length or the sensitivity of vibration of the LVA is always constant during the closed loop control irrespective of the change of battery voltage or the application of external damping force. The use of a micro-controller in commercially available cellular phones etc. strongly supports the implementation of the closed loop control. The back emf can be easily sensed by an A/D converter present within the micro-controller. Hence, the control technique can be realized without much additional cost.

The LVA may preferably be operated at a resonant frequency at higher battery voltage (2.9V to 4.2V) and lower turn-on duty (10% to 15%), thus providing the equal stroke length, that is, the same sensitivity of vibration as when operated at lower battery voltage (1.2V to 1.6V) and higher turn-on duty (40% to 50%). The average current flowing through the LVA in both cases is the same, making the LVA when operated at higher battery voltage more energy efficient.

### 2.1 First Exemplary Embodiment of the Control Method

The first algorithm of the control method of LVA 11 is described below, in which a PWM ON-duty is changed in steps based on the detected back emf of the LVA 11 while an operating frequency of the LVA 11 is constant.

The first algorithm has the salient features as follows.

(i) The LVA is always operated at a pre-determined constant resonant frequency (f_{rc}).

(ii) The initial PWM ON-duty (α) at starting is also pre-determined.

(iii) These parameters (f_{rc} and α) depend on the LVA characteristics, the desired reference back emf peak point (Bₚᵣ) and the required starting response. It is noted that the parameters (f_{rc} and α) and the other parameters are stored in advance to a data storage means of the control apparatus such as a ROM (or a hard disk) of the micro-controller.

(iv) The LVA is brought under closed loop operation from the first cycle and the magnitude of the back emf peak point (Bₚ) is continuously sensed and compared with the value of the reference back emf peak point (Bₚᵣ). If the error between Bₚ and Bₚᵣ exceeds a pre-determined tolerance value (δ), the PWM ON-duty (α) is changed in steps by a very small percentage of PWM ON-duty which is equal to (Δα), until the back emf peak point (Bₚ) again reaches near to the reference value (Bₚᵣ) making the sensitivity of the vibration unaltered. For better reliability of closed loop control, an upper limit (αₘₐₓ) and a lower limit (αₘᵢₙ) of the PWM ON-duty is defined for the LVA 11. The value of Δα which is very much dependent on the system design, may remain constant throughout or may vary proportionally with respect to the magnitude of error between Bₚ and Bₚᵣ.

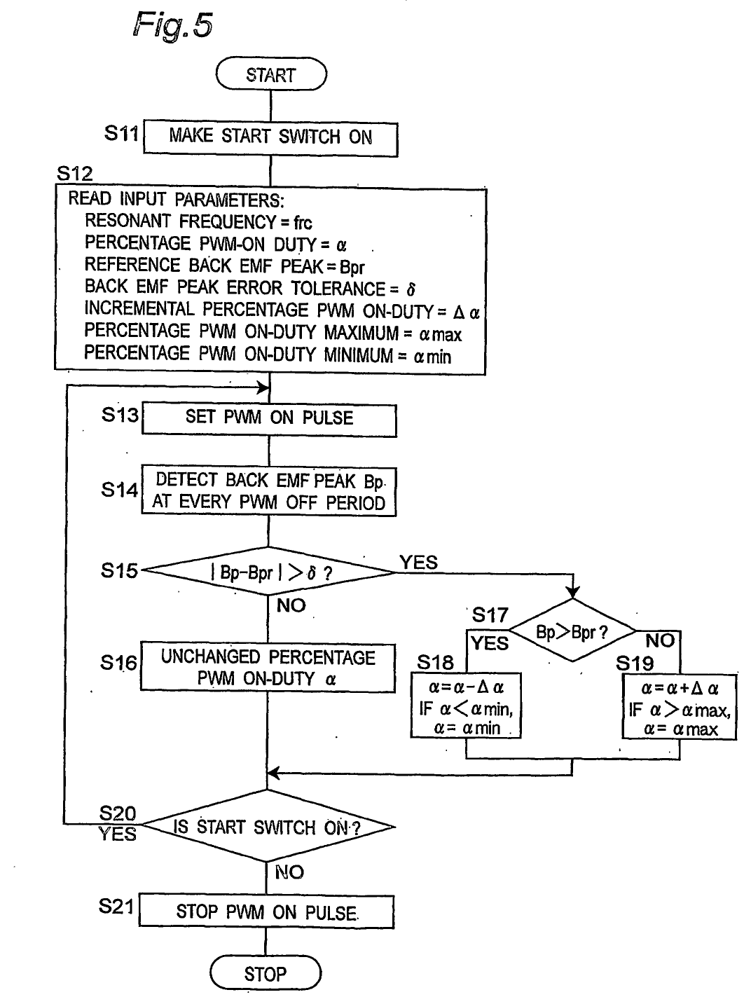

Detail description is made to the first algorithm with reference to FIG. 5. It is noted that the following procedure is performed by the micro-controller 30.

When a start switch of the control apparatus is turned on (S11), values of several parameters are read from the data storage means in the control apparatus (S12). Based on the initialised PWM ON-duty, PWM ON pulse is set (S13). The back emf peak Bₚ is detected by the interface circuit at every PWM OFF period (S14). Error between the detected back emf peak Bₚ and the reference back emf peak Bₚᵣ is compared with an error tolerance δ (S15).

If the error (|Bₚ-Bₚᵣ|) between the detected back emf peak Bₚ and the reference back emf peak Bₚᵣ is within the error tolerance δ (S15), a percentage of the duty α is not changed (S16): If the error (|Bₚ-Bₚᵣ|) exceeds the error tolerance δ (S15), a percentage of the duty α is changed. That is, if Bₚ>Bₚᵣ (S17), the duty α is decreased by the predetermined value Δα (S18), otherwise it is increased by the predetermined value Δα (S19). Then the micro-controller 30 instructs the switch driver to drive the transistor QN1 with the obtained duty α.

The above procedure (S13 to S19) is repeated while the start switch is kept on (S20). When the start switch is turned off, the output of PWM ON pulse is terminated (S21).

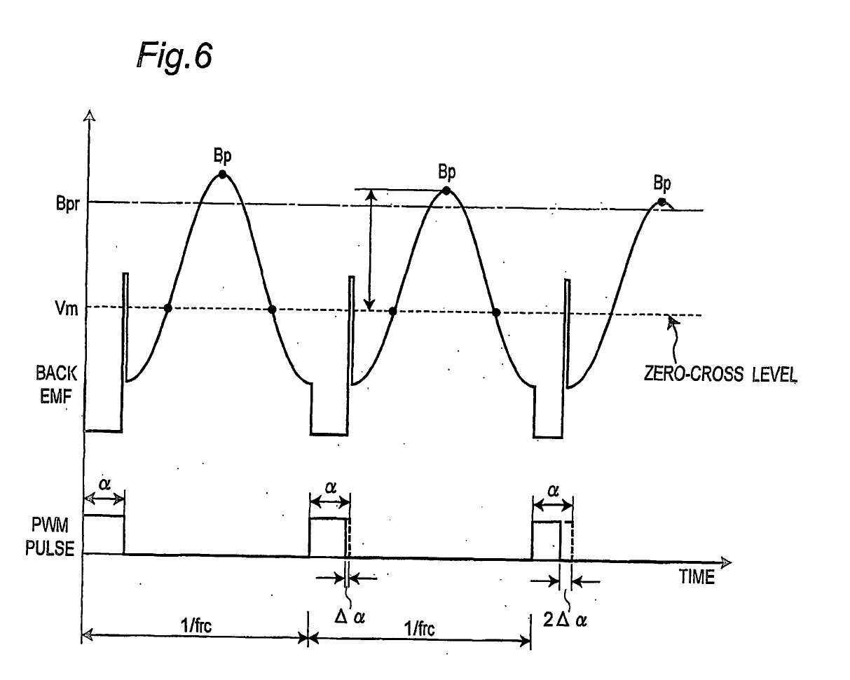

FIG. 6 shows a waveform of the back emf of the LVA 11 when the above control method is applied to the apparatus shown in FIG. 3A. From FIG. 6, it can be seen that the percentage of the duty α is changed by the predetermined value Δα so as to keep the back emf peek Bₚ constant (=Bₚᵣ).

### 2.2 Second Exemplary Embodiment of the Control Method

The second algorithm of the control method of the LVA 11 is described below, in which an operating frequency of the LVA 11 is changed in steps based on the detected back emf of the LVA 11 while the PWM ON-duty is constant.

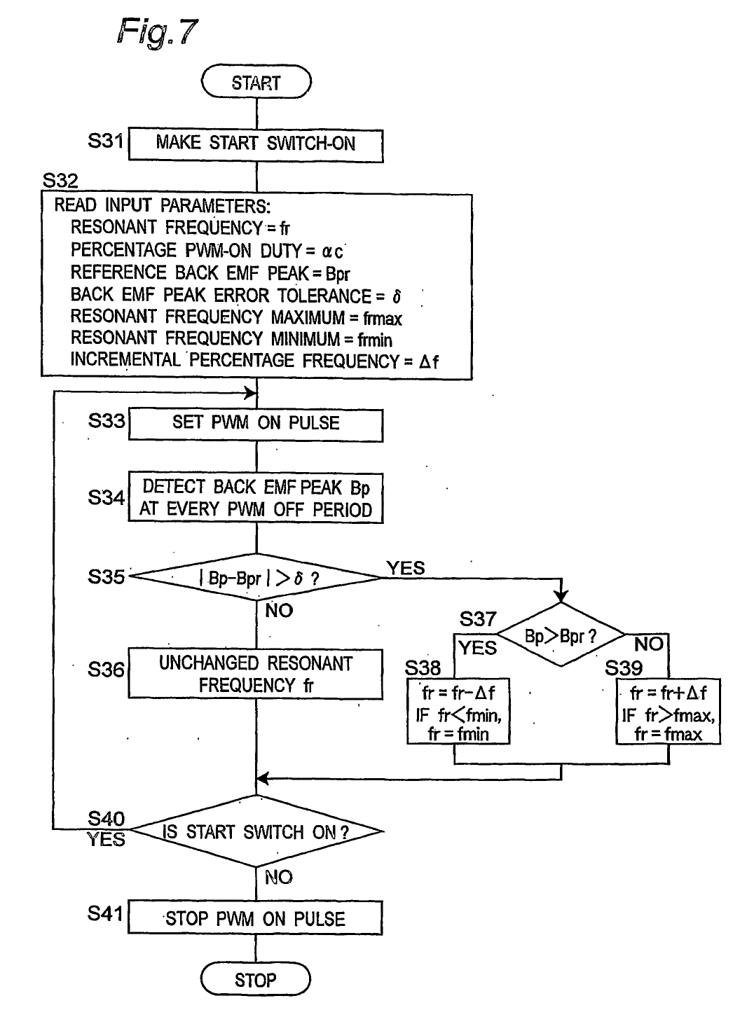

Referring to FIG. 7, salient features of the second algorithm of the control method of LVA 11 are described as follows.

(i) The LVA 11 is always operated at a pre-determined fixed PWM ON-duty (α_{c}). The fixed PWM ON-duty (α_{c}) is first read as well as other parameters (S32) after switch-on.

(ii) An operating frequency of the LVA during starting is equal to a pre-determined resonant frequency (fᵣ).

(iii) The parameters (α_{c} and fᵣ) depend on the LVA characteristics, the desired reference back emf peak point (Bₚᵣ) and the required starting response.

(iv) The LVA is brought under a closed loop operation from the first cycle and the magnitude of the back emf peak point (Bₚ) is continuously sensed (S34), and compared with the value of the reference back emf peak point (Bₚᵣ) (S35). If the error between (Bₚ) and (Bₚᵣ) exceeds a predetermined tolerance value (δ), the operating frequency is changed in steps by a very small percentage of resonant frequency equal to (Δf) (S37 to S39), until the back emf peak point (Bₚ) again reaches near to the reference value (Bₚᵣ) making the sensitivity of the vibration unaltered. If the error between (Bₚ) and (Bₚᵣ) is within the error tolerance δ, a percentage of the operating frequency fᵣ is not changed (S36). The above procedure (S33 to S39) is repeated while the start switch is kept on (S40).

For better reliability of the closed loop control, an upper limit (fₘₐₓ) and a lower limit (fₘᵢₙ) of the resonant frequency is defined for the LVA. The value of (Δf) which greatly depends on the system design, may remain constant throughout or may vary proportionally with respect to the magnitude of the error between (Bₚ) and (Bₚᵣ).

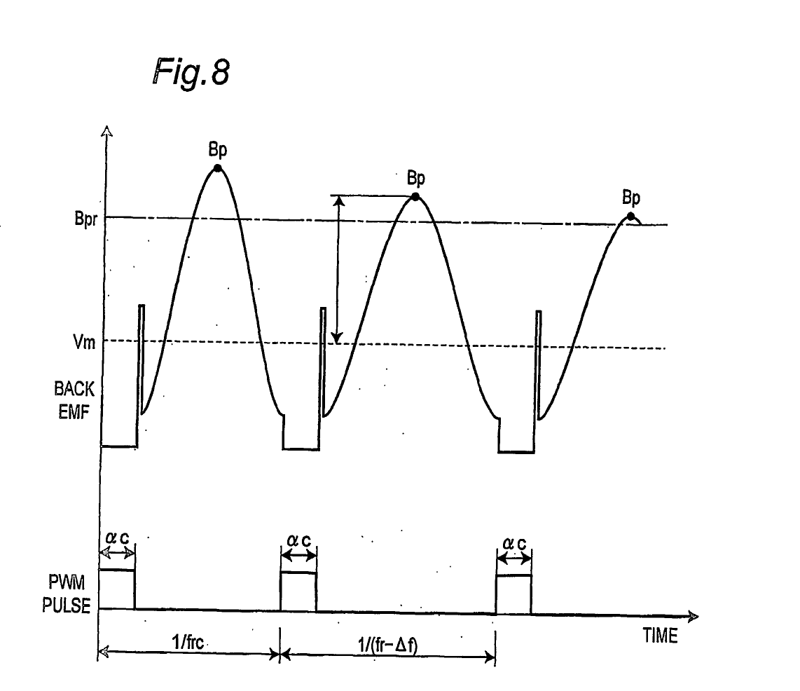

FIG. 8 shows a waveform of the back emf of the LVA under the second algorithm. From FIG. 8, it can be seen that the operating frequency fᵣ is changed by the predetermined value Δf so as to keep the back emf peak Bₚ constant (=Bₚᵣ).

### 2.3 Third Exemplary Embodiment of the Control Method

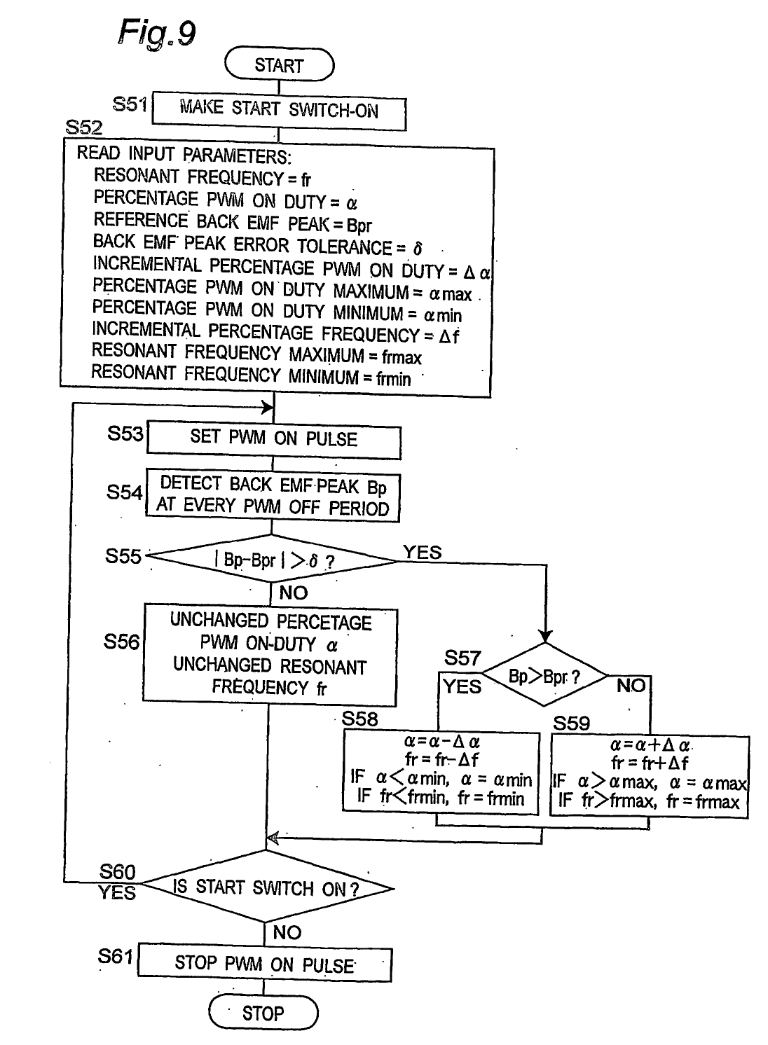

The third algorithm of the control method of LVA 11 is described below with reference to FIG. 9 showing a flow chart of the third algorithm.

Referring to FIG. 9, unlike the first and second algorithms, both the PWM ON-duty (α) and the resonant frequency (fᵣ) are changed simultaneously (S58, S59), so that the back emf peak point (Bₚ) always follow the reference back emf peak point (Bₚᵣ). Simultaneous change of both these parameters also ensures that the PWM ON-duty is always located at the center between zero-cross (Z₀) and (Z₁).

### 2.4 Fourth Exemplary Embodiment of the Control Method

The fourth algorithm of the control method of the LVA 11 is described below, in which an open loop operation is first performed during a predetermined number (N) of cycles and subsequently a closed loop operation is performed. In the closed loop operation, a turn-on delay (t_{ond}) is set so that a PWM duty pulse is located at the center of an interval between a zero-cross point Z₁ in a negative slope of the back emf and a zero-cross point Z₀ in a positive slope of the back emf. The turn-on delay (t_{ond}) is an interval from the zero-cross point Z₁ in a negative slope of the back emf to a start of a PWM duty pulse.

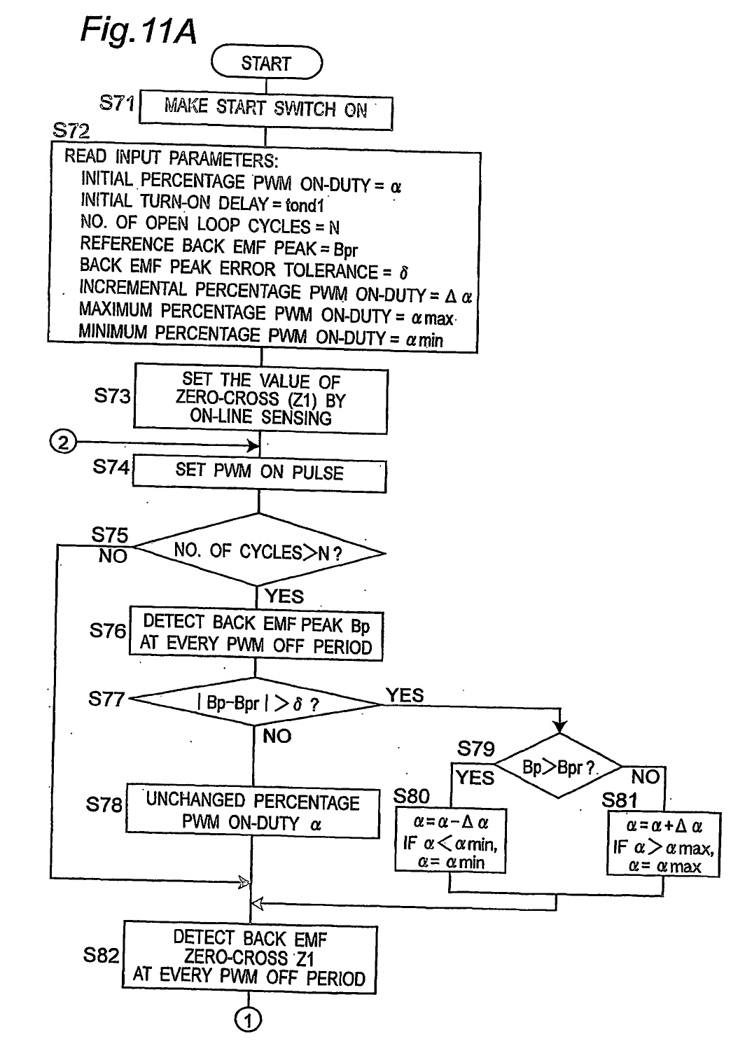

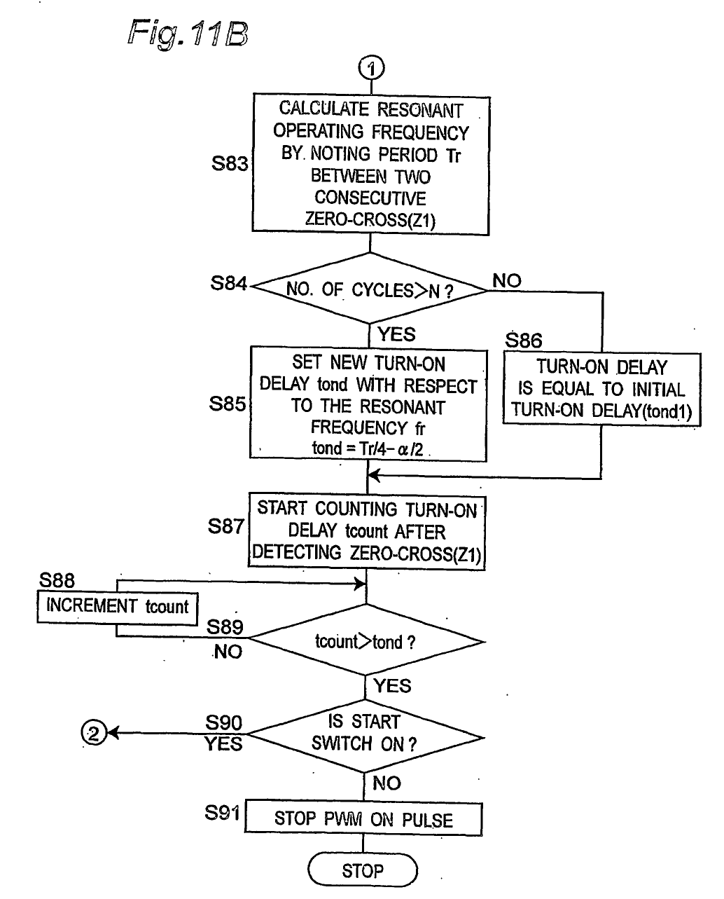

Referring to FIGS. 11A and 11B, salient features of the fourth algorithm are described in detail as follows.

(i) The LVA 11 is started in open loop operation with a pre-determined initial PWM ON-duty (α). It is noted from the flow chart shown in FIGS. 11A and 11B, that the mode of operation, either open loop or closed loop is determined based on the number (N) of cycles (S75, S84).

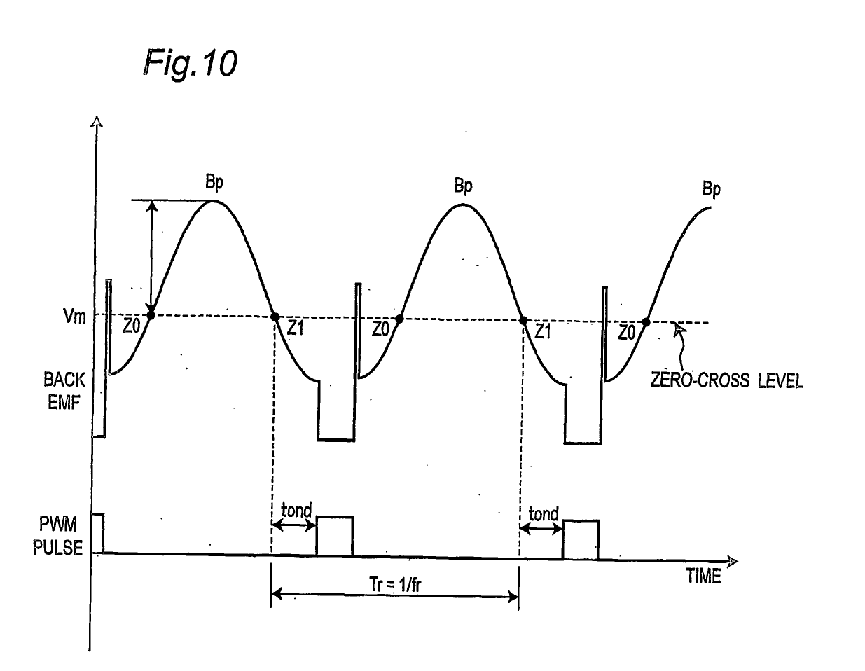

(ii) The drive transistor QN1 is always turned ON after sensing the zero-cross point (Z₁) in the negative slope region of the back emf (S73), and a turn-on delay (t_{ond}) as shown in FIG. 10 is provided (S84, S86). The turn-on delay indirectly controls the operating frequency of the LVA 11.

(iii) The starting PWM ON-duty (α) and the initial turn-on delay (t_{ond1}) are kept constant during the open loop operation (S78). The values of these two parameters depend on the LVA characteristics, the desired reference back emf peak point (Bₚᵣ) and the required starting response. After few initial cycles equal to (N), the LVA is brought into the closed loop operation (S75, S84).

(iv) During the closed loop operation, the magnitude of the back emf peak point (Bₚ) is continuously sensed (S76), and compared with the value of the reference back emf peak point (Bₚᵣ) (S77). If the error between (Bₚ) and (Bₚᵣ) exceeds a pre-determined tolerance value (δ) (S77), the PWM ON-duty is changed in steps by a very small percentage of PWM ON-duty equal to Δα (S79, S80, S81), until the back emf peak point (Bₚ) again reaches near to the reference value (Bₚᵣ) (S77). Thus, the sensitivity of vibration is unaltered. For better reliability of the closed loop control, an upper limit (αₘₐₓ) and a lower limit (αₘᵢₙ) of the PWM ON-duty (α) is defined for the LVA 11 (refer to S80, 81). The value of Δα which greatly depends on the system design, may remain constant throughout or may vary proportionally with respect to the magnitude of error (|Bₚ-Bₚᵣ|).

(v) During the closed loop operation, the operating frequency of the LVA 11 is calculated by detecting the time period between two consecutive zero-cross points (Z₁) (S82, S83). The turn-on delay is continuously updated with respect to the operating frequency (S85), so that the PWM ON-duty is always at the center of the two zero-cross points (Z₀) and (Z₁). This indirectly assures operation of the LVA at a resonant frequency (fᵣ). The turn-on delay t_{ond} in the closed loop operation is obtained by an equation of (Tᵣ/4-α/2) in which Tᵣ equals to 1fᵣ. The drive transistor QN1 is turned on when a period of turn on delay of t_{ond} elapses from the zero-cross point Z₁ of the back emf in the negative slope. In this embodiment, the period of turn on delay t_{ond} is measured by a counter t_{count} which counts up a clock (S87 to S90).

### 2.5 Fifth Exemplary Embodiment of the Control Method

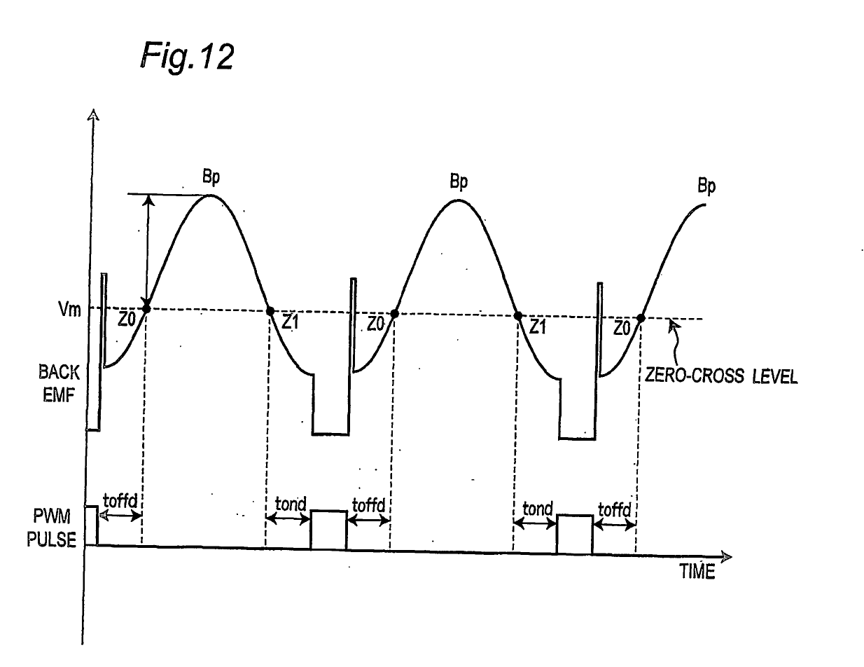

The fifth algorithm of the control method of the LVA 11 is described below. The previously mentioned salient features (i) to (iv) for the fourth algorithm are same for the fifth algorithm too. The major difference between the fourth and fifth algorithms lies in the sensing of another zero-cross point (Z₀) in the positive slope region of the back emf during the closed loop operation to estimate a turn-off delay (t_{offd}) on-line and make the turn-on delay (t_{ond}) equal to the turn-off delay (t_{offd}) as shown in FIG. 12.

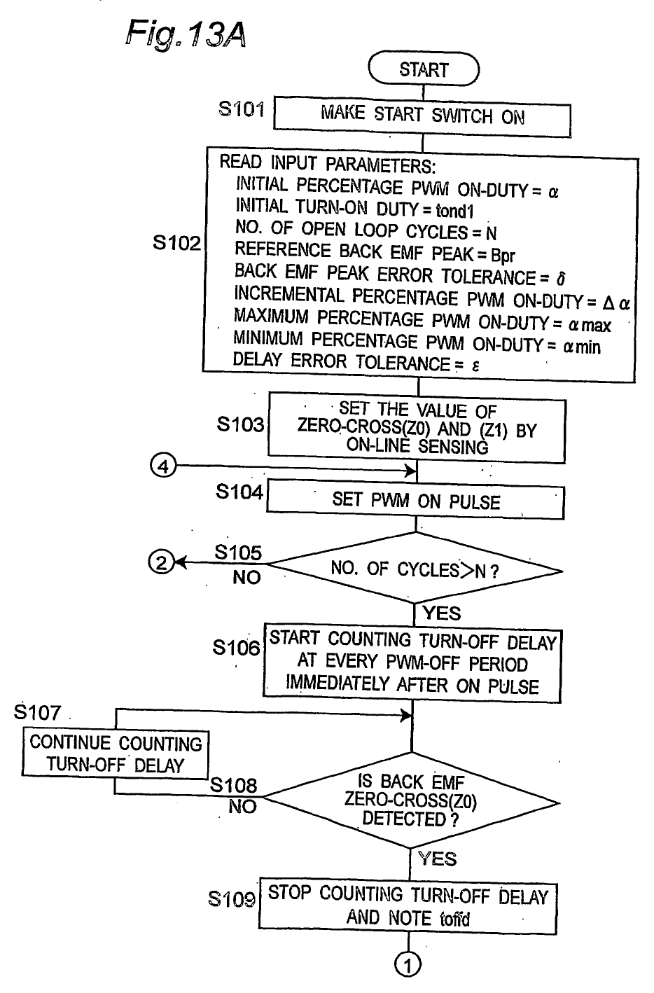

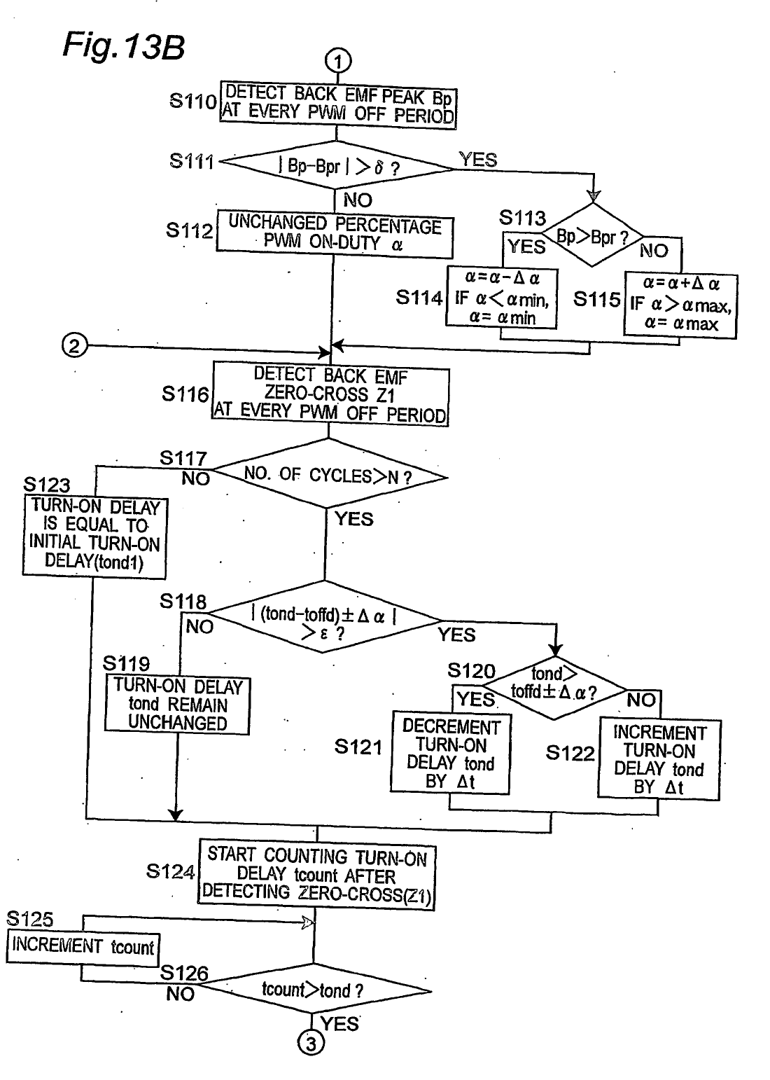

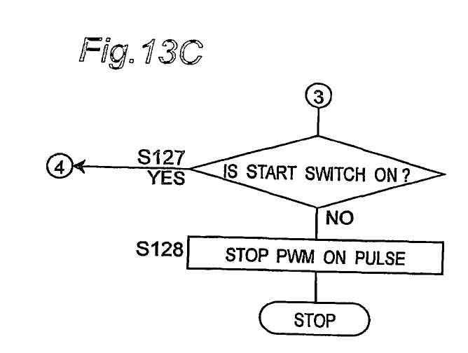

Referring to FIGS. 13A to 13C, salient features of the fifth algorithm are described in detail as follows.

(i) In the closed loop operation, a turn-off delay (t_{offd}) is estimated or noted by counting up a clock from the instant when the PWM pulse turns off to the instant when the back emf zero-cross point (Z₀) is detected (S106 to S109).

(ii) If the error between the set turn-on delay (t_{ond}) and the estimated turn-off delay (t_{offd}) exceeds a pre-determined tolerance value (ε) (S118), the turn-on delay (t_{ond}) is changed in steps by a small period equal to (Δt) (S120 to S122), so that it again becomes nearly equal to turn-off delay (t_{offd}). If the difference does not exceeds the tolerance value (ε), the turn-on delay (t_{ond}) is not changed (S119). The value of (Δt) which greatly depends on the system design, may remain constant throughout or may vary proportionally with respect to the magnitude of error between (t_{ond}) and (t_{offd}). This algorithm directly assures that the PWM ON-duty is always at the center of the two zero-cross (Z₀) and (Z₁) and the LVA is thus operating on resonant frequency (fᵣ).

A PWM pulse is made output when a period of the turn on delay (t_{ond}) elapses after detecting the zero-cross point (Z₁) (S124 to 126).

### 2.6 Sixth Exemplary Embodiment of the Control Method

The sixth algorithm of the control method of the LVA 11 is described below. The features of the sixth algorithm is basically the same as the fourth algorithm; In the sixth algorithm the turn-on delay (t_{ond}) is defined based on the back emf peak point (Bₚ).

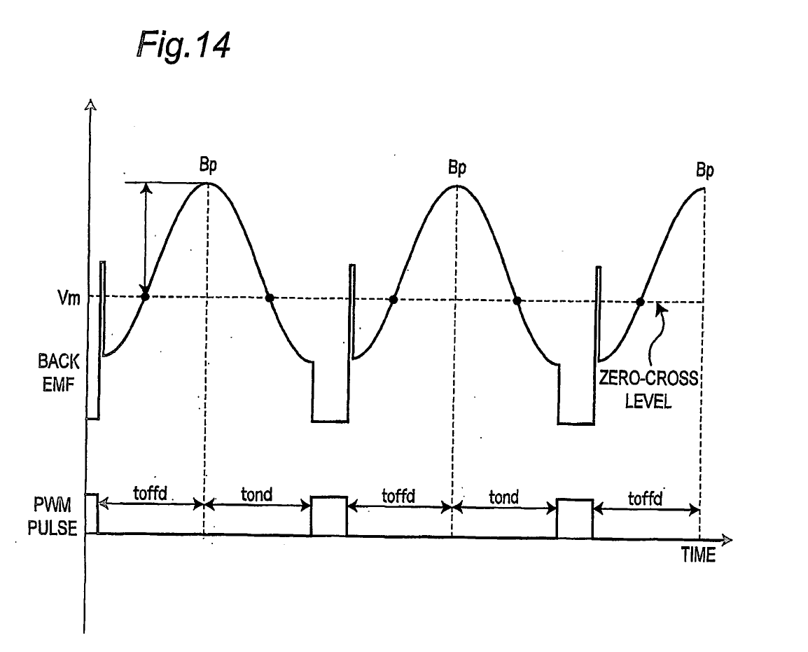

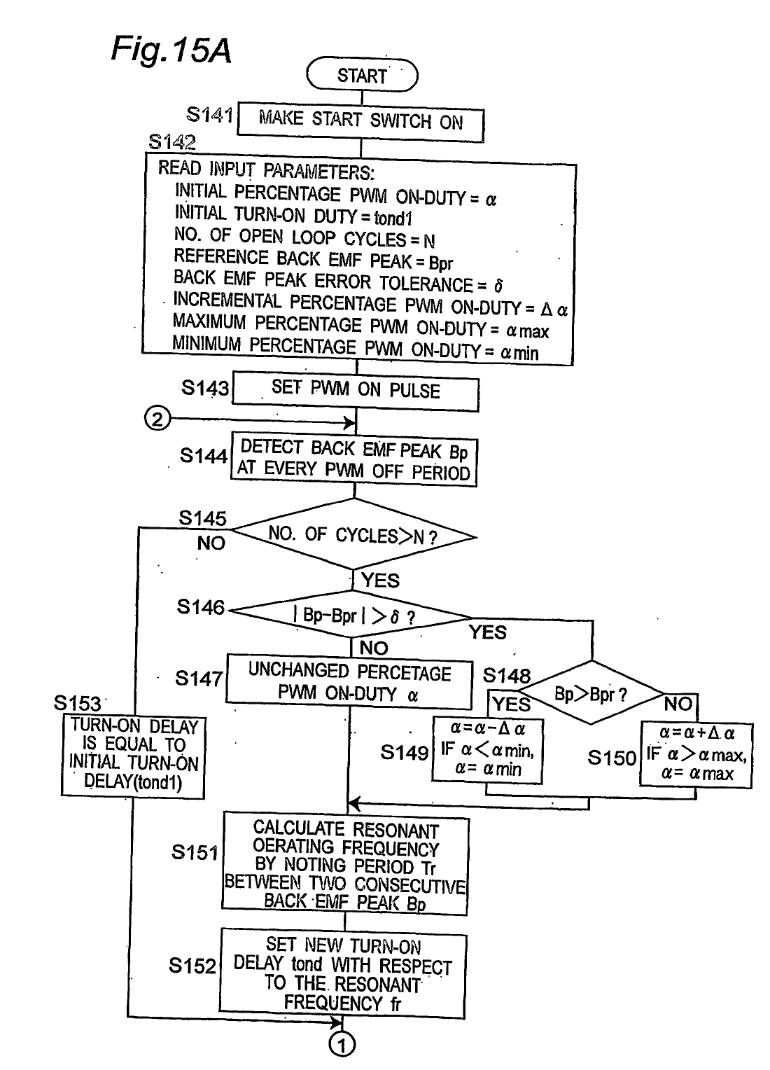

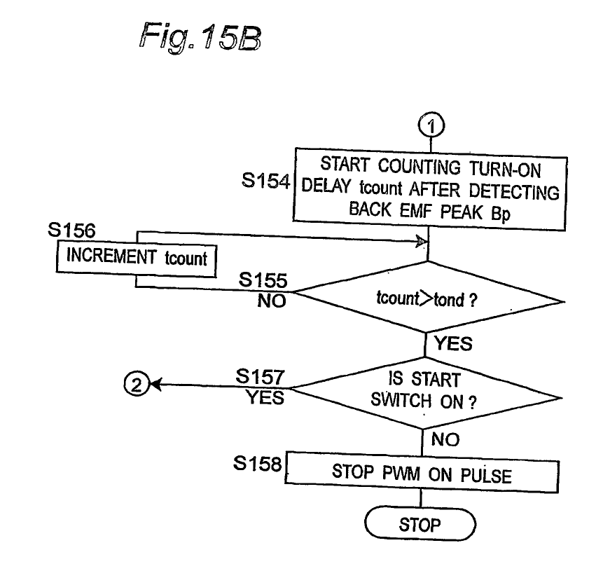

The flow chart for the sixth algorithm is shown in FIGS. 15A and 15B. As shown in the flow chart, in the sixth algorithm, the zero-cross point (Z₁) is not sensed. The operating frequency of the LVA 11 is calculated by noting the time period between two consecutive back emf peak points (Bₚ) (S151). The turn-on delay (t_{ond}) is defined from the back emf peak point (Bₚ) with respect to the resonant frequency fᵣ (S152), as shown in FIG. 14. It is noted that the turn-on delay (t_{ond}) can be defined by (Tᵣ/4-α/2).

### 2.7 Seventh Exemplary Embodiment of the Control Method

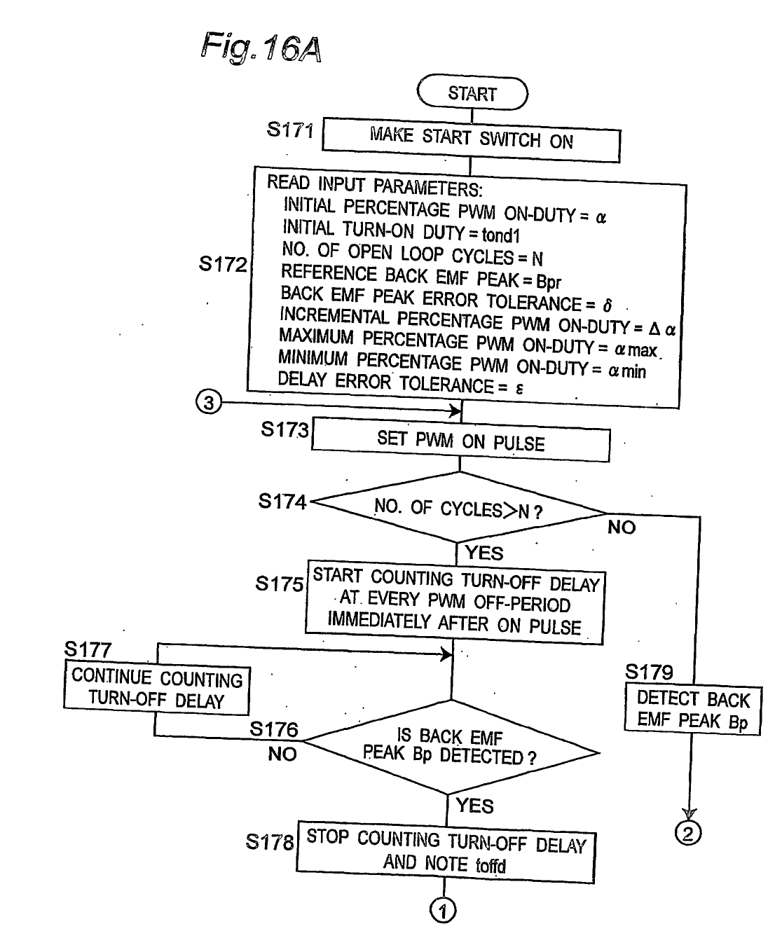

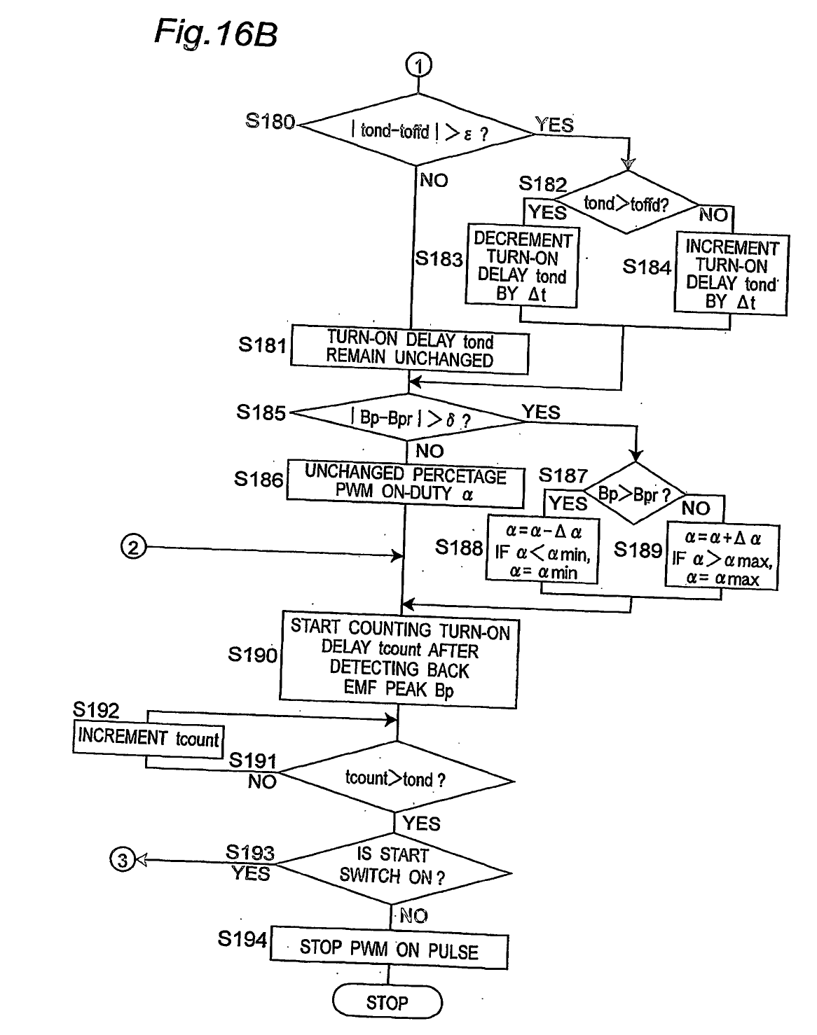

The seventh algorithm of the control method of the LVA 11 is described below. The features of the seventh algorithm is basically the same as the fifth algorithm. In the seventh algorithm, the zero-cross points (Z₀) and (Z₁) are not sensed, and the turn-on delay (t_{ond}) and the turn-off delay (t_{offd}) as shown in FIG. 14 are defined from the back emf peak point (Bₚ). The flow chart for the seventh algorithm is shown in FIGS. 16A and 16B.

As shown in the flowchart, the turn-off delay (t_{offd}) is known by the detection timing of the back emf peak points (Bₚ). That is, the turn-off delay (t_{offd}) is noted by counting clocks from the end of PWM pulse to the detection of the back emf peak point (Bₚ) (S175 to S178). The turn-on delay (t_{ond}) is made equal to the turn-off delay (t_{offd}) (S180 to S184).

### 3. INDUSTRIAL AND COMMERCIAL APPLICABILITY

Closed loop control of the LVA as described above is ideal for generating vibration in cellular phones, game controllers, toys, healthy bands etc. as the sensitivity of vibration can be always made constant. The presence of micro-controller in all these systems helps to implement the closed-loop control of the LVA without any additional cost.

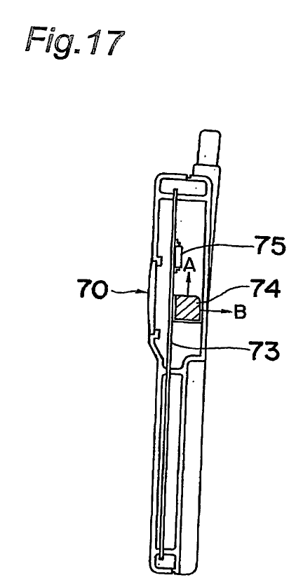

FIG. 17 shows an exemplary application of the LVA to a cellular phone. The cellular phone 70 contains a circuit board on which a vibrator 74 including a LVA vibrating in a direction indicated by A or B and a drive circuit 75 which is a micro-controller driving the LVA in the above described control method. The LVA in the vibrator 74 is driven by the drive circuit 75 when the cellular phone receives a incoming call signal.

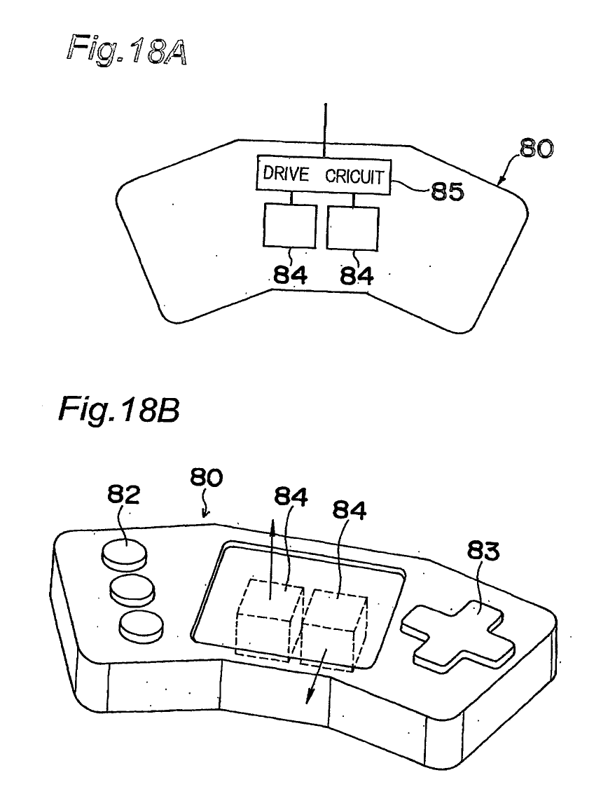

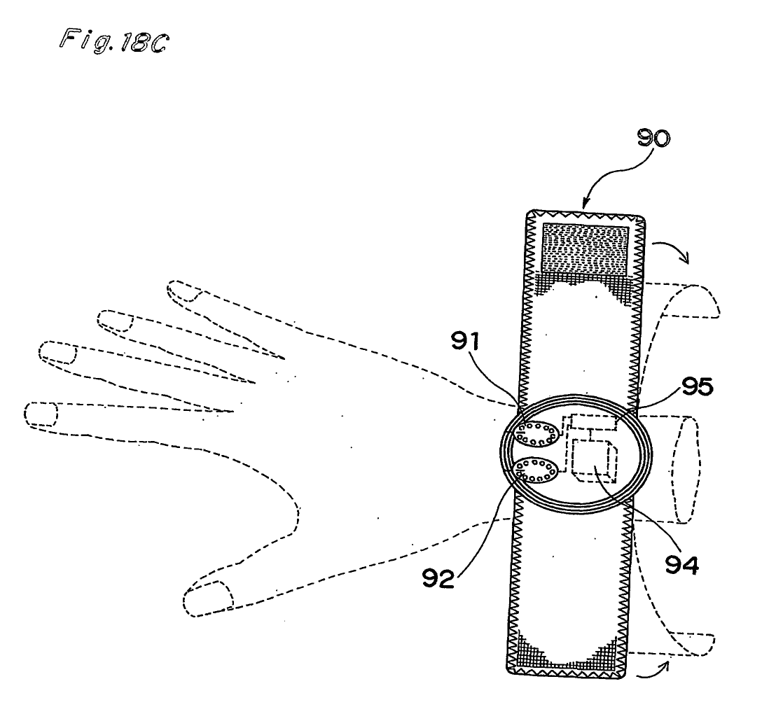

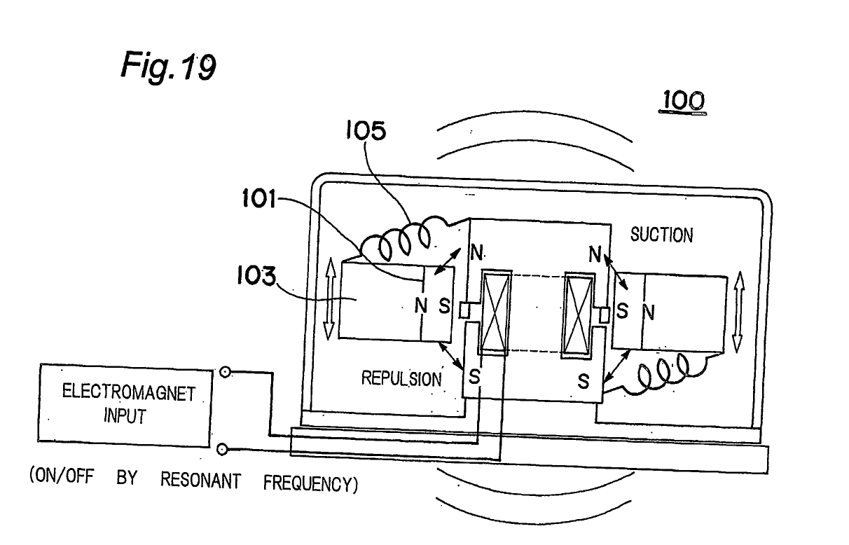

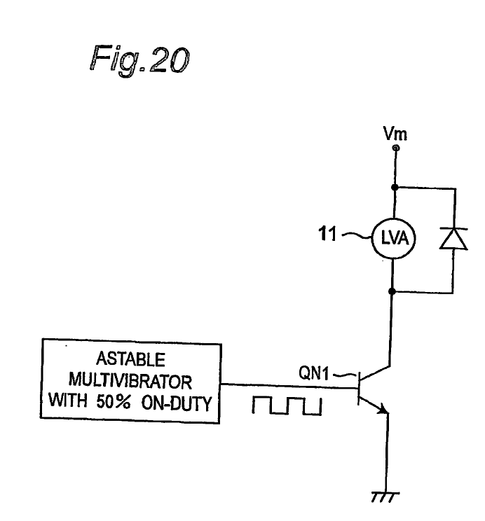

FIGS. 18A and 18B show an exemplary application of the LVA to a game controller which sends a control signal according to user's operation to a host game machine and receives a control signal from the host game machine. The game controller 80 has control buttons 82 and a control pad 83, and also contains vibrators 84 each including a LVA and a drive circuit 85 which is a micro-controller driving the LVA in the above described control method. The LVA in each vibrator 84 is driven by the drive circuit 85 according to the control signal from the host game machine.

FIGS. 18C shows an exemplary application of the LVA to a healthy band. The healthy band 90 is provided with a switch knob 91, a vibrating level adjustment knob 92, a LVA 94, and a drive circuit 95 driving the LVA 94 with a vibration level set by the adjustment knob 92. Impression of vibration at typical frequencies at the hand, head or the leg of a human being can improve the blood circulation and can help to maintain a normal blood pressure. Hence, the LVA with different resonant frequencies and closed-loop control can be used for an application such as healthy bands connected to the hand or the head or the leg.

Although the present invention has been described in connection with specified embodiments thereof, many other modifications, corrections and applications are apparent to those skilled in the art. Therefore, the present invention is not limited by the disclosure provided herein but limited only to the scope of the appended claims.

1. An apparatus for controlling a linear vibration actuator comprising:
a switching element that alternately turns on and off to provide power intermittently to the linear vibration actuator;
a drive circuit that drives the switching element in a PWM control method;
an interface circuit that detects the back electromotive force of the linear vibration actuator during the OFF period of the switching element, the interface circuit connected between the junction point of the switching element and the linear vibration actuator and the AD input terminal of the controller; and
a controller that controls the drive circuit based on the back electromotive force detection result by the interface circuit such that the switching element is driven at a resonant frequency,
wherein the controller controls the drive circuit so that magnitude of a crest or peak point of the back electromotive force is kept constant and a PWM ON-period is located at the center of consecutive zero cross points of the back electromotive force.

2. The apparatus according to claim 1, wherein the interface circuit comprises a level shift circuit including an operational amplifier.

3. The apparatus according to claim 1, wherein the interface circuit comprises clamping diodes and a filter circuit.

4. The apparatus according to claim 3, wherein the interface circuit further comprises a resistor divider network between the junction point and the clamping diodes.

5. (canceled)

6. A closed loop control method of a linear vibration actuator which vibrates linearly and energized through a switching element driven in a PWM control method, the method comprising:
detecting a crest or peak point (Bc, Bp) of a back electromotive force occurring in the linear vibration actuator;
comparing the detected crest or peak point (Bc, Bp) with a reference value (Bcr, Bpr); and
adjusting at least one of the parameters such as the PWM duty (α) applied to the switching element and the operating frequency (fr) of the linear vibration actuator, so that the crest or peak point (Bc, Bp) of the back electromotive force is constant.

7. The closed loop control method of claim 6, wherein the control includes adjusting the PWM duty while keeping the operating frequency constant.

8. The closed loop control method of claim 6, wherein the control includes adjusting the operating frequency while keeping the PWM duty constant.

9. The closed loop control method of claim 6, wherein the control includes adjusting both the PWM duty and the operating frequency.

10. A closed loop control method of a linear vibration actuator which vibrates linearly and energized by a switching element driven in a PWM control method, the method comprising:
detecting the zero cross point (Z1) in the negative slope region of the back electromotive force occurring in the linear vibration actuator;
calculating an operating frequency of the linear vibration actuator based on the period between two consecutive zero cross points (Z1) in the negative slope region of the back electromotive force; and
driving the switching element with the calculated operating frequency, while turning on the switching element after a turn-on delay (tond) from the instant after detecting the zero cross points (Z1) of the back electromotive force and thereby updating the turn-on delay (tond) based on the calculated operating frequency so that the PWM duty (α) is located at the center of two consecutive zero cross points (Z0) and (Z1), and continuously adjusting the PWM ON-duty (α) after sensing the peak or crest point (Bp or Bc) of the back electromotive force and comparing it with the value of the reference peak or crest point (Bpr or Bcr) of the back electromotive force.

11. A closed loop control method of a linear vibration actuator which vibrates linearly and energized by a switching element driven in a PWM control method, the method comprising:
detecting a zero cross point (Z0) in the positive slope region and a zero cross point (Z1) in the negative slope region of a back electromotive force occurring in the linear vibration actuator;
estimating a turn-off delay (toffd) based on the zero cross point (Z0) in the positive slope region, the turn-off delay (toffd) being an interval between a turn-off instant of the PWM duty pulse and an instant when the zero cross point (Z0) in the positive slope region is detected;
changing the turn-on delay (tond) so that the turn-on delay (tond) is substantially equal to the turn-off delay (toffd); and
driving the switching element so as to turn it on with the turn-on delay (tond) after the zero cross point (Z1) in the negative slope region is detected, and continuously adjusting the PWM ON-duty (α) after sensing the peak or crest point (Bp or Bc) of the back electromotive force and comparing it with the value of the reference peak or crest point (Bpr or Bcr) of the back electromotive force.

12. A closed loop control method of a linear vibration actuator which vibrates linearly and energized by a switching element driven in a PWM control method, the method comprising:
detecting a peak or crest point (Bp or Bc) of the back electromotive force occurring in the linear vibration actuator;
defining a turn-on delay (tond) based on the detected peak or crest point (Bp or Bc) of the back electromotive force;
calculating an operating frequency of the linear vibration actuator based on the period between two consecutive peak or crests (Bp or Bc) of the back electromotive force; and
driving the switching element with the calculated operating frequency, while turning on the switching element with the turn-on delay (tond) after detecting the peak or crest point (Bp or Bc) of the back electromotive force.

13. A closed loop control method of a linear vibration actuator which vibrates linearly and energized by a switching element driven in a PWM control method, the method comprising:
detecting a peak or crest point (Bₚ or B_{c}) of a back electromotive force occurring in the linear vibration actuator;
defining a turn-on delay (t_{ond}) and a turn-off delay (t_{offd}) based on the detected peak or crest point (Bₚ or B_{c}) of the back electromotive force, the turn-off delay (t_{offd}) being an interval between a turn-off instant of the PWM duty pulse and an instant corresponding to the peak or crest point (Bₚ or B_{c}) of the back electromotive force;
changing the turn-on delay (t_{ond}) so that the turn-on delay (t_{ond}) is substantially equal to the turn-off delay (t_{offd}); and
driving the switching element so as to turn on the switching element with the turn-on delay (t_{ond}) after detecting the peak or crest point (Bₚ or B_{c}) of the back electromotive force is detected.

14. A cellular phone comprising a linear vibration actuator and a control circuit which controls the linear vibration actuator in the control method according to claim 6.

15. A game controller comprising a linear vibration actuator and a control circuit which controls the linear vibration actuator in the control method according to claim 6.

16. A healthy band connected to the human body comprising a linear vibration actuator and a control circuit which controls the linear vibration. actuator in the control method according to claim 6.

17. A cellular phone comprising a linear vibration actuator and a control circuit which controls the linear vibration actuator in the control method according to claim 13.

18. A game controller comprising a linear vibration actuator and a control circuit which controls the linear vibration actuator in the control method according to claim 13.

19. A healthy band connected to the human body comprising a linear vibration actuator and a control circuit which controls the linear vibration actuator in the control method according to claim 13.

20. A cellular phone comprising a linear vibration actuator and a control circuit which controls the linear vibration actuator in the control method according to claim 10.

21. A game controller comprising a linear vibration actuator and a control circuit which controls the linear vibration actuator in the control method according to claim 10.

22. A healthy band connected to the human body comprising a linear vibration actuator and a control circuit which controls the linear vibration actuator in the control method according to claim 10.

23. A cellular phone comprising a linear vibration actuator and a control circuit which controls the linear vibration actuator in the control method according to claim 11.

24. A game controller comprising a linear vibration actuator and a control circuit which controls the linear vibration actuator in the control method according to claim 11.
